(19) United States
(12) Patent Application Publication
(10) Pub. No.: US 2014/0133950 A1
(43) Pub. Date: May 15, 2014

(54) Insertion/Extraction Tool For Components In Housing

(71) Applicant: John Pollock, (US)

(72) Inventor: John Pollock, (US)

(73) Assignee: VEECO INSTRUMENTS, INC., Plainview, NY (US)

(21) Appl. No.: 13/675,278

(22) Filed: Nov. 13, 2012

(51) Int. Cl. B66F 3/08

(52) U.S. Cl. CPC B66F 3/08
USPC 414/800; 254/100

(57) ABSTRACT

An insertion/extraction tool for inserting and extracting components in a housing includes a clamp member that attaches to a component in the housing. A lift member includes a bearing attached to the clamp member. A bridge includes a threaded member attached to the clamp member with a lead screw. The lead screw is threaded through the threaded member in the bridge and terminated at the bearing attached to the clamp member. The lead screw raises and lowers the lift member as it rotates, thereby translating the component relative to the housing.

The section headings used herein are for organizational purposes only and should not to be construed as limiting the subject matter described in the present application in any way.

### INTRODUCTION

Many types of process systems include components in a housing that require frequent removal during normal operation. In these systems, removal is required to insert materials to be processed and also to remove materials after processing. One such system is a Vapor Phase Epitaxy (VPE) system. Vapor phase epitaxy is a type of chemical vapor deposition (CVD) which involves directing one or more gases containing chemical species onto a surface of a substrate so that the reactive species react and form a film on the surface of the substrate. For example, VPE systems can be used to grow compound semiconductor materials on substrates.

Materials are typically grown by injecting at least one precursor gas and, in many processes, at least a first and a second precursor gas into a process chamber containing the crystalline substrate. Compound semiconductors, such as III-V semiconductors, can be formed by growing various layers of semiconductor materials on a substrate using a hydride precursor gas and an organometalic precursor gas. Metalorganic vapor phase epitaxy (MOVPE) is a vapor deposition method that is commonly used to grow compound semiconductors using a surface reaction of metalorganics and hydrides containing the required chemical elements. For example, indium phosphide could be grown in a reactor on a substrate by introducing trimethylindium and phosphine.

Alternative names for MOVPE used in the art include organometallic vapor phase epitaxy (OMVPE), metalorganic chemical vapor deposition (MOCVD), and organometallic chemical vapor deposition (OMCVD). In these processes, the gases are reacted with one another at the growth surface of a substrate, such as a sapphire, Si, GaAs, InP, InAs or GaP substrate, to form a III-V compound of the general formula In_{X}Ga_{Y}Al_{Z}As_{B}P_{C}Sb_{D}, where X+Y+Z equals approximately one, and A+B+C+D equals approximately one, and each of X, Y, Z, A, B, C, and D can be between zero and one. In various processes, the substrate can be a metal, semiconductor, or an insulating substrate. In some instances, bismuth may be used in place of some or all of the other Group III metals.

Compound semiconductors, such as III-V semiconductors, can also be formed by growing various layers of semiconductor materials on a substrate using a hydride or a halide precursor gas process. In one halide vapor phase epitaxy (HVPE) process, Group III nitrides (e.g., GaN, AN) are formed by reacting hot gaseous metal chlorides (e.g., GaCl or AlCl) with ammonia gas (NH₃). The metal chlorides are generated by passing hot HCl gas over the hot Group III metals. One feature of HVPE is that it can have a very high growth rate, up to 100 μm per hour for some state-of-the-art processes. Another feature of HVPE is that it can be used to deposit relatively high quality films because films are grown in a carbon free environment and because the hot HCl gas provides a self-cleaning effect.

In these processes, the substrate is maintained at an elevated temperature within a reaction chamber. The precursor gases are typically mixed with inert carrier gases and are then directed into the reaction chamber. Typically, the gases are at a relatively low temperature when they are introduced into the reaction chamber. As the gases reach the hot substrate, their temperature, and hence their available energy for reaction, increases. Formation of the epitaxial layer occurs by final pyrolysis of the constituent chemicals at the substrate surface. Crystals are formed by a chemical reaction on the surface of the substrate and not by physical deposition processes. Consequently, VPE is a desirable growth technique for thermodynamically metastable alloys. Currently, VPE is commonly used for manufacturing laser diodes, solar cells, and light emitting diodes (LEDs).

Some VPE systems include a rotating disk reactor. For example, U.S. Provisional Patent Application No. 61/648,646, entitled “Substrate Carrier for Chemical Vapor Deposition” describes a CVD system having a rotating disk reactor design. The entire contents of U.S. Provisional Patent Application No. 61/648,646 are incorporated herein by reference. The rotating disk reactor described this patent application includes a turntable positioned in the vacuum chamber. A cylindrical dielectric support, such as a quartz support, is coupled to the turntable so that the turntable rotates the dielectric support.

### SUMMARY OF THE INVENTION

An insertion/extraction tool for components in a housing, such as a CVD reactor comprising a rotating dielectric support, includes a clamp member that attaches to a component in the housing and a lift member that attaches to the clamp member. The clamp member and the lift member can be formed in a ring shape. The lift member includes a bearing that terminates a lead screw. A bridge having a threaded member, such as a nut, is attached to the clamp member. A lead screw is threaded through the threaded member in the bridge and has a first end terminated in the lift member bearing. A hand wheel can be attached to a second end of the lead screw. The lead screw raises and lowers the lift member as it rotates by rotating the hand wheel or other means, thereby translating the component relative to the housing. In some embodiments, at least one guide pin is attached to the bridge and aligned to an aperture defined in the lift member so as to substantially prevent the lift member from rotating relative to the bridge.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. In the drawings, like reference characters generally refer to like features and structural elements throughout the various figures. The drawings are not intended to limit the scope of the Applicants' teaching in any way.

FIG. 1 illustrates a CVD reactor where the insertion/extraction tool according to the present teaching can be used to insert and extract components.

FIG. 2 illustrates a perspective view of one embodiment of an insertion/extraction tool according to the present teaching for a component of a CVD reactor.

FIG. 3 illustrates a side-view of the insertion/extraction tool according to the present teaching.

FIG. 4 illustrates an expanded-view of the component/clamp member interface illustrating the attachment of the clamp member to the component.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The present teaching relates to methods and apparatus for inserting and removing components in a housing, such as the type of housing included in a chemical vapor deposition system, such as a MOCVD system. More particularly, the present teaching relates to methods and apparatus for inserting and removing components in chemical vapor deposition systems having vertical reactors in which the substrates are located on a rotating disk.

Recently, there has been tremendous growth in the LED and OLED markets. Consequently, there has been an increased demand for efficient CVD and MOCVD manufacturing systems and methods. There is a particular need for manufacturing systems and methods that improve process throughput.

Aspects of the present teaching are described in connection with a CVD reactor housing and components thereof. However, one skilled in the art will appreciate that the methods and apparatus of the present teaching can be implemented with numerous other types of equipment comprising a housing that includes fragile or difficult to reach components that need to be inserted and removed. In particular, one skilled in the art will appreciate that the present teachings are not limited to CVD reactors or processing equipment for the semiconductor and material science industries.

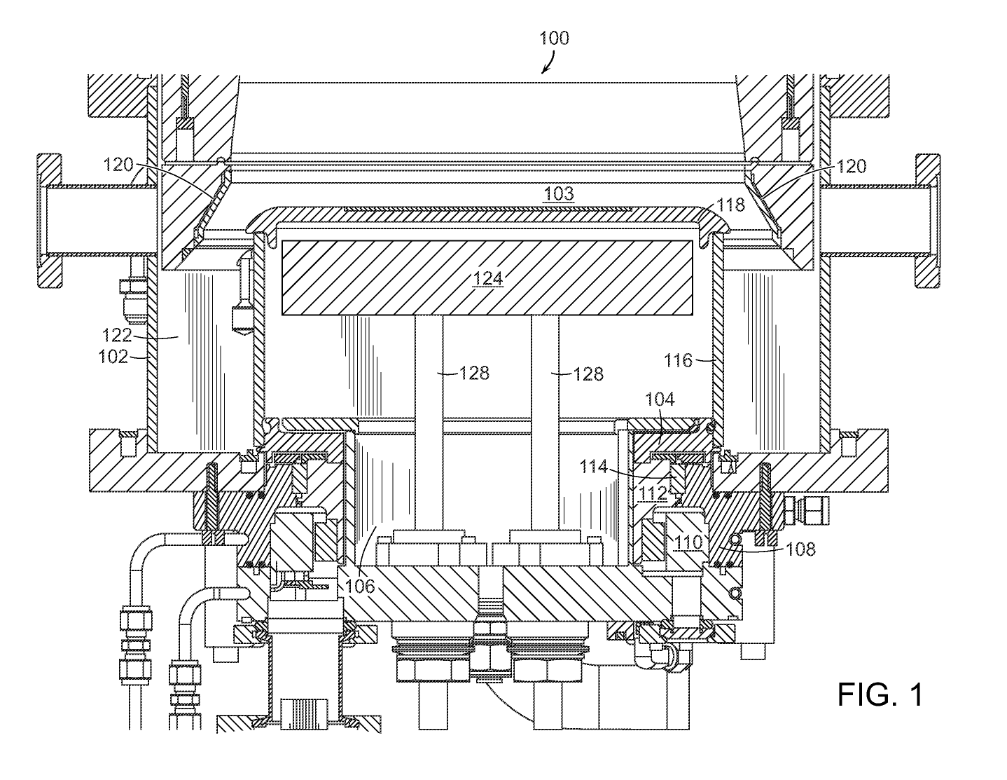

FIG. 1 illustrates a CVD reactor where the insertion/extraction tool according to the present teaching can be used to insert and extract components. The CVD reactor 100 includes a vacuum chamber 102, which is often formed of stainless steel. The vacuum chamber 102 provides a vacuum environment for CVD processing of a single substrate or of a batch of substrates. One example of a process that can be performed with the CVD reactor 100 is depositing thin films by CVD, such as GaN based thin films grown on sapphire substrates for LED manufacturing.

A turntable 104 is positioned in a cool region 106 of the vacuum chamber 102. The cool region 106 is maintained at a relatively low temperature during normal processing conditions so that it can enclose low temperature components, such as the bearings and the motor for rotating the turntable 104. The bottom of the turn table assembly 104 includes a bearing or guide wheel system that allows for rotation. A housing 108 encloses a motor 110 that is used to rotate the turntable 104. In the embodiment shown, the motor 110 is mechanically coupled to the turntable 104 by a rotatable spindle 112 in a direct drive configuration. That is, the motor is directly coupled to the rotatable spindle 112. The term “directly coupled” as defined herein means that the motor is coupled to the rotatable spindle 122 without any intermediate mechanism, such as a belt. There are no feedthroughs in the vacuum chamber for a motor shaft.

The spindle 112 contains some dielectric material. For example, the spindle 112 can be formed at least in part of quartz or boron nitride. Also, the spindle 112 can comprises a hollow shaft that, in some embodiments, is formed of a dielectric material like quartz. Dielectric materials have numerous advantages over metal for this application. For example, dielectric materials will remain cooler during some processing conditions and, therefore, will provide less thermal loss compared with metal spindles and will also reduce heat transfer to the motor and other components in the cool section 106. For example, a spindle 112 formed of quartz will significantly reduce thermal losses compared to a metal shaft spindle.

The turntable 104 can be coupled to the spindle 112 in numerous different ways, such as by mechanical coupling, by magnetic coupling, or by electromechanical coupling. There are no feedthroughs in the vacuum chamber 102 for shafts or spindles that drive belts in these embodiments like in some prior art CVD reactors. The turntable 104 can be coupled to the spindle 112 with a magnetically coupled drive. In various embodiments, the magnetically coupled drive can be coupled from inside and outside of the vacuum chamber 102. Such magnetically coupled drives directly couple the motor 110 to the spindle 112 rather than indirectly couple the motor using belt drives. In these embodiments, the motor 110 drives a magnetic ring on the atmospheric side that is magnetically coupling to a matching magnetic ring in the vacuum side. For example, the matching magnetic ring can be mounted to the bottom of the spindle 112. Alternatively, the motor stator mounted outside vacuum can drive the motor rotor mounted inside vacuum through a non-ferrous, thin-walled section of the vacuum chamber.

A rotating dielectric support 116 is positioned on top of the turntable 104 and can be mechanically coupled to the turntable 104 by various means. For example, the rotating dielectric support 116 can be a hollow dielectric cylinder or tube that attaches to the turntable 104 with springs or other means. The rotating dielectric support 116 can be formed of quartz.

Quartz is a particularly good dielectric material for the rotating dielectric support 116 because it is relatively inexpensive, can be used with high processing temperatures, and has a very low coefficient of thermal expansion so the dimensions of the dielectric material do not change significantly during high temperature processing. In addition, quartz has low thermal conductivity so it functions as a thermal barrier between the substrates being processed and the cool region 106. Using quartz will reduce or minimize temperature non-uniformities on the substrate carrier.

Using a quartz rotating dielectric support 116 also has several design advantages. For example, a quartz support 16 can be much shorter in dimension compared with similar CVD reactors that use metal or high thermal conductivity dielectric materials because less material will be needed to thermally isolate the substrate carrier 118 from the cool area 106. Such shorter supports 116 will result in smaller reactors that are much less expensive to manufacture and also to operate. Another design advantage of using quartz for the support 116 is that the thermal expansion coefficient of a quartz support 116 will be many times lower than the thermal expansion coefficient of the substrate carrier 118. Therefore, as the substrate carrier 118 heats up it will expand at a much greater rate than the quartz support 116. The mismatch in CTE's can be used by design to cause the substrate carrier to center itself with respect to the quartz support as temperatures rise. The substrate support 116 will become more concentric to the quartz support 116 and thus held in place more firmly as the temperature increases, which will result in improved process uniformity. Another design advantage of using quartz for the support 116 is that it will be much easier for the heater 124 to maintain a uniform processing temperature over the entire substrate carrier.

However, using a quartz rotating dielectric support 116 has the significant disadvantage that it is fragile and thus can be easily damaged especially when being inserted and extracted from the CVD process chamber. Therefore, inserting and extracting a quartz rotating dielectric support 116 requires substantial care to avoid damage. The insertion/extraction tool according to the present teaching can be used to insert and extract the quartz rotating dielectric support 116 without damage and by using only modest skills.

A substrate carrier 118 is positioned on top of the rotating dielectric support 116. The substrate carrier 118 has at least one recessed portion that is dimensioned to receive at least one substrate for processing. The spindle 112 rotates the turntable 104 that supports the substrate carrier 118. The spindle 112 contacts the dielectric support 116 at the outer edge.

A heater 124 is positioned proximate to the substrate carrier 118. The heater 124 can be is positioned inside of the rotating dielectric support 116 proximate to and below the substrate carrier 118 so that there is strong thermal communication between the heater 124 and the substrate carrier 118. Alternatively, the heater 124 can be positioned outside of the rotating dielectric support 116.

The rotating dielectric support 116 is physically attached to the turntable assembly 104. The rotating dielectric support 116 can be attached to the turntable 104 using coil springs. For example, a canted coil spring could be used. These coil springs can be formed of stainless steel to reduce reactions of the coil spring with process gasses. The coil springs are retained by a groove in the rotating flange. A matching groove can be formed in the dielectric support 116 to allow the coil spring to partially re-expand as the rotating dielectric support 116 is inserted around and seated against the rotating flange. As the rotating dielectric support 116 is inserted into the turntable 104 from above, the coil spring is compressed radially inward. The groove in the rotating dielectric support 116 allows the coil spring to partially re-expand as insertion continues, which more securely attaches the rotating dielectric support 116 to the turntable 104. The coil spring holds the rotating dielectric support 116 against the rotating flange with a predetermined force. The coil spring is generally designed to position the rotating dielectric support 116 concentrically around to the rotating flange.

Using a coil spring to attach the rotating dielectric support 116 to the turntable 104 has numerous advantages. For example, the coil spring provides a forgiving point of contact that accommodates thermal expansion during CVD processing. The coil spring allows differential expansions to occur without creating any significant stresses in the rotating dielectric support 116, which is particularly important if quartz is used for the rotating dielectric support 116. Also, the coils spring keeps the dielectric support 116 more symmetrically positioned, which will reduce wobble and, therefore, allow for higher rotation rates during processing. Also, the coil spring limits heat transfer between the rotating dielectric support 116 and the rotating flange. Therefore, using the coil spring results in less thermal loss by adding some level of thermal resistance and, therefore, less heat transfer from the heater 124 to the cool region 106 of the CVD reactor 100. The dielectric support 116 coupled with springs are essentially thermally floating. Therefore, the coil spring greatly reduces heat transfer to the motor 110 and bearing 114 and also greatly reduces thermal stresses between the rotating dielectric support 116 and the vacuum chamber 102 which is often formed of stainless steel. Thus, using coil springs can significantly reduce maintenance.

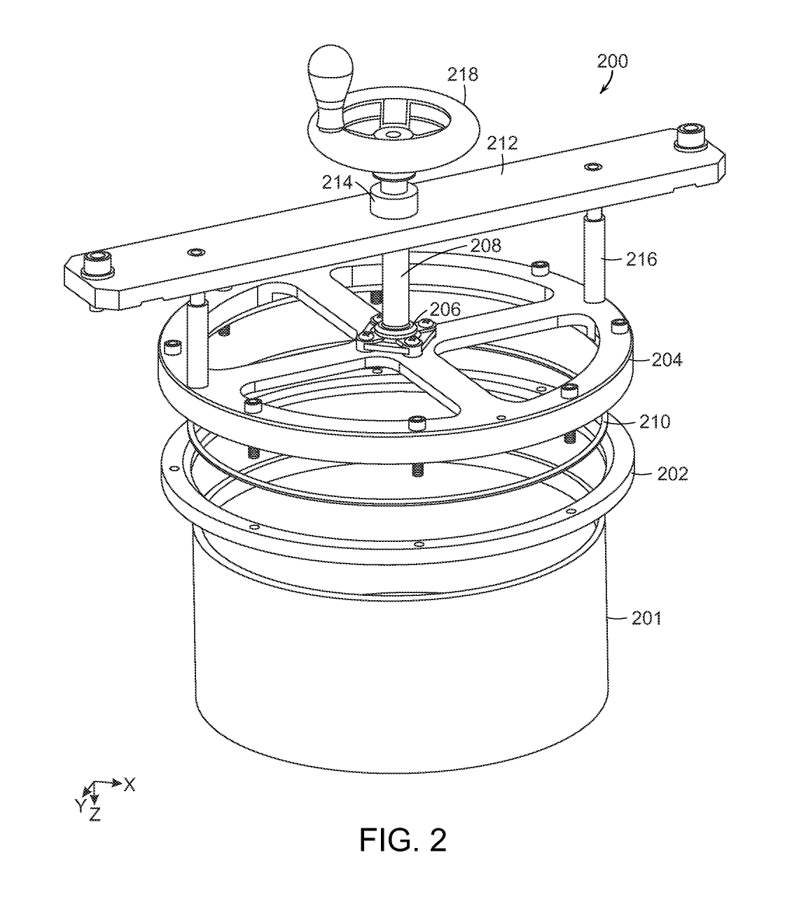

FIG. 2 illustrates a perspective view of one embodiment of an insertion/extraction tool 200 according to the present teaching for a component of a CVD reactor. Although the present teaching is described in connection a CVD reactor, it is understood that the insertion/extraction tool of the present teaching can be used to insert and/or extract component from any type of housing.

The insertion/extraction tool 200 includes a clamp member 202 that attaches to a component 201 in the CVD reactor. In one embodiment, the clamp member 202 is shaped in a ring. Referring to the CVD reactor described in connection with FIG. 1, the insertion/extraction tool 200 can be used to insert and extract the rotating dielectric support 116. As described herein, it is highly desirable for the rotating dielectric support 116 to be formed of quartz. However, quartz is very fragile and, therefore, must be inserted and extracted with great care to avoid damage.

The dielectric support 116 is coupled to the turntable 104, which rotates the dielectric support 116. A substrate carrier 118 is positioned on the dielectric support 116 so that the turntable 104 rotates the substrate carrier 118 during processing. During normal operation, the dielectric support 116 including substrates to be process is inserted with the insertion/extraction tool 200 and then is removed with the insertion/extraction tool 200 after the substrates are processed.

A lift member 204 is attached to the clamp member 202 by fasteners or some other type of a removable attachment means. For example, the lift member 204 can be attached to the clamp member 202 using various removable fasteners, such as bolts 205. In one embodiment, the lift member 204 is shaped in a ring. The lift member 204 includes a bearing 206 for terminating a lead screw 208. In one embodiment, a spherical bearing can be used to terminate the lead screw 208. Also, in one embodiment, an o-ring 210 or similar structure is used between the clamp member 202 and the lift member 204 as shown in FIG. 2.

A bridge 212 attaches to the lift member 204 via the lead screw 208. The bridge 212 includes a threaded member 214 for receiving the lead screw 208. In the embodiment shown in FIG. 2, the threaded member 214 is a nut. In some embodiments, guide pins 216 are used to align the bridge 212 to the lift member 204 and also to substantially prevent motion of the lift member 204 relative to the bridge 212. In the embodiment shown in FIG. 1, two guide pins 216 are positioned proximate to the outer surface of the lift member 204.

The lead screw 208 is threaded through the threaded member 214 in the bridge 212. A first end of the lead screw 208 is terminated at the bearing 206 in or on the lift member 204. A second end of the lead screw 208 includes a means to easily rotate the lead screw 208. For example, in one embodiment, a hand wheel 218 is attached to the second end of the lead screw 208. In other embodiments, a nut is attached to the second end of the lead screw 208 so that a wrench can be used to rotate the lead screw 208.

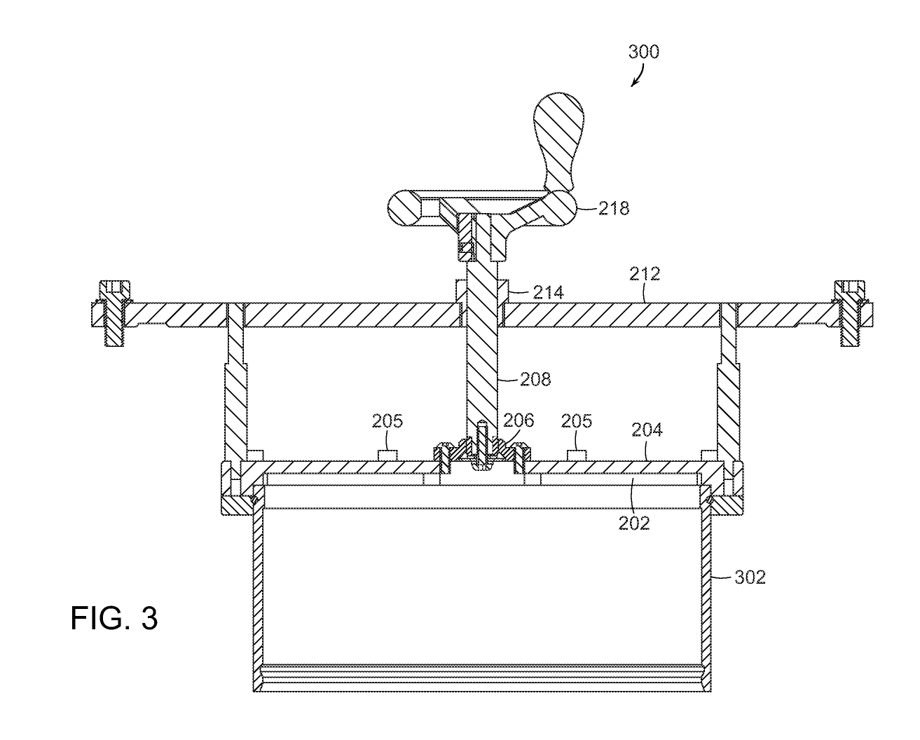

FIG. 3 illustrates a side-view of the insertion/extraction tool 300 according to the present teaching. As with FIG. 2, the present teaching is illustrated in connection with a CVD reactor where the component 302 being inserted/extracted is the rotating dielectric support 116 described in connection with FIG. 1. One skilled in the art will appreciate that the insertion/extraction tool of the present teaching can be used to insert and extract numerous types of components from numerous types of housings.

Referring to FIGS. 1-3, the side-view of the insertion/extraction tool 300 illustrates the component 302 with the clamp member 202 attached to its top surface. The lift member 204 is attached to the clamp member 202 with bolts 205 as shown in FIG. 3. The bearing 206 is positioned on the top surface of the lift member 204. The lead screw 208 is threaded through the threaded member 214 of the bridge 212. The first end of the lead screw 208 is terminated at the bearing 206. A second end of the lead screw 208 is terminated with a hand wheel 218 that is easily rotated in order to translate the component 302 up and down with the insertion/extraction tool 300. The rigid lead-screw drive provides precise, controlled movement of when raising and lowering the component 302. This prevents sudden, uncontrolled movements that might cause damage to fragile components, such as quartz components.

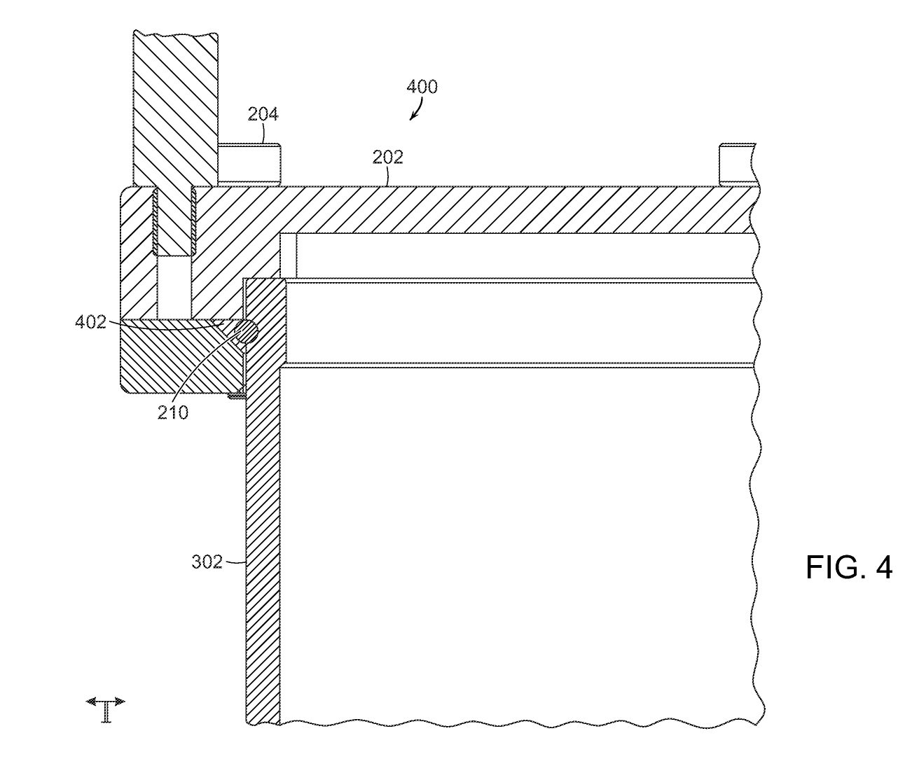

FIG. 4 illustrates an expanded view of the component/clamp member interface 400 illustrating the attachment of the clamp member 202 to the component 302. Referring to FIGS. 1-4, the clamp member 202 is positioned on the component 302 as shown in FIG. 4. The lift member 204 is attached to the claim member 202. When the clamp member 202 is attached to the lift member 204 with the bolts 205, the o-ring 210 captured between the clamp member 202 and the lift member 204 is compressed inward against the component 302 by a tapered groove 402 in the clamp member 202. The resulting compressed o-ring 210 secures the component 302 to the lift member 204 with a precisely controlled force so that the component 302 is not damaged. This is particularly important for components formed of quartz and other fragile materials.

The methods for inserting and extracting a component using the insertion/extraction tool according to the present teaching are described in connection with inserting and extracting the rotating dielectric support 116 shown in FIG. 1, which includes the substrate carrier 118 containing at least one substrate for processing. However, it is understood that the methods of the present teaching apply to inserting and extracting any type of component in any type of housing.

Typically, the rotating dielectric support 116 is placed on a bench in a clean room where a substrate carrier 118 containing at least one substrate for processing is positioned on the rotating dielectric support 116. Referring to FIGS. 1-4, the clamp member 202 is fit around the outer diameter of the dielectric support 116. The bottom of the lift member 204 is lowered until it contacts the top of the dielectric support 116. The clamp member 202 around the outer diameter of the dielectric support 116, is then drawn up against the bottom surface of the lift member 204 using an array of fasteners, such as bolts, around its perimeter. As the clamp member 202 is drawn to the lift member 204, the o-ring 210 captured between the clamp member 202 and the lift member 204 is compressed inward against the dielectric support 116 by the tapered groove 402 in the clamp member 202. The compressed o-ring 210 secures the dielectric support 116 to the lift member 204 with a precisely controlled force so that the dielectric support 116 is not damaged. This is particularly important for quartz dielectric supports.

Once the dielectric support 116 is secured, the insertion/extraction tool 200 securing the dielectric support 116 is positioned over the housing, which in this case is the CVD reactor vacuum chamber 102. The hand-wheel 218 is then rotated to lower the dielectric support 116 into the CVD chamber using the lead-screw 208 drive to lower the dielectric support 116 with a precise, controlled movement so that the dielectric support 116 engages the springs that holds the dielectric support 116 to the turntable 104 in the CVD reactor vacuum chamber 102. The two guide pins 216 located proximate to the outer diameter and protruding from the top of the lift member 204 pass through the clearance holes in the bridge 212 to prevent the lift member 204 from rotating relative to the clamp member 202 while the lead screw 208 is rotated. The shoulders in each guide pin 216 stop and steady the lift member 204 against the bridge 212. Using the lead screw drive assembly described herein prevents sudden, uncontrolled movement that might cause damage to the fragile dielectric support 116.

The operation for removing a component after processing or other procedure is performed in a similar manner to the operation for inserting the component in the housing. For removing a component, such as the rotating dielectric support 116 shown in FIG. 1, the clamp member 202 is fit around the outer diameter of the dielectric support 116. The bottom of the lift member 204 is then lowered until it contacts the top of the dielectric support 116. The clamp member 202 around the outer diameter of the dielectric support 116, is drawn up against the bottom surface of the lift member 204 using an array of fasteners, such as bolts, around its perimeter. As the clamp member 202 is drawn to the lift member the o-ring 210 captured between the clamp member 202 and the lift member 204 is compressed inward against the dielectric support 116 by the tapered groove 402 in the clamp member 202. The compressed o-ring 210 secures the dielectric support 116 to the lift member with a precisely controlled force.

Once the dielectric support 116 is secured, the hand-wheel 218 is rotated to raise the dielectric support 116. The two guide pins located proximate to the outer diameter and protruding from the top of the lift member 204 pass through the clearance holes in the bridge 212 to prevent the lift member 204 from rotating relative to the clamp member 202 while the lead screw 208 is rotated. The shoulders in each pin stop and steady the lift member 204 against the bridge 212. The entire insertion/extraction tool 200 with the dielectric support 116 attached is then removed from the CVD reactor.

### EQUIVALENTS

While the applicants' teaching is described in conjunction with various embodiments, it is not intended that the applicants' teaching be limited to such embodiments. On the contrary, the applicant's teaching encompass various alternatives, modifications, and equivalents, as will be appreciated by those of skill in the art, which may be made therein without departing from the spirit and scope of the teaching.

What is claimed is:

1. An insertion/extraction tool for components in a housing, the insertion/extraction tool comprising:
a) a clamp member that attaches to a component in the housing;
b) a lift member that attaches to the clamp member, the lift member comprising a bearing;
c) a bridge comprising a threaded member that is attached to the clamp member; and
d) a lead screw that is threaded through the threaded member in the bridge, the lead screw having a first end terminated in the lift member bearing, wherein the lead screw raises and lowers the lift member as it rotates, thereby translating the component relative to the housing.

2. The insertion/extraction tool of claim 1 further comprising at least one guide pin attached to the bridge and aligned to an aperture defined in the lift member so as to substantially prevent the lift member from rotating relative to the bridge.

3. The insertion/extraction tool of claim 1 wherein the housing is a CVD reactor.

4. The insertion/extraction tool of claim 3 wherein the component of the CVD reactor comprise a dielectric support that is mechanically coupled to a turntable.

5. The insertion/extraction tool of claim 4 further comprising a substrate carrier positioned on the dielectric support so that the turntable rotates the substrate carrier.

6. The insertion/extraction tool of claim 1 wherein the clamp member is formed in a ring shape.

7. The insertion/extraction tool of claim 1 wherein the lift member is formed in a ring shape.

8. The insertion/extraction tool of claim 1 wherein the lead screw comprises a hand wheel attached to a second end.

9. The insertion/extraction tool of claim 1 wherein the threaded member comprises a nut.

10. The insertion/extraction tool of claim 1 wherein the lift member is attached to the clamp member with fasteners.

11. The insertion/extraction tool of claim 10 wherein the fasteners are bolts.

12. The insertion/extraction tool of claim 1 wherein the bearing comprises a spherical bearing.

13. The insertion/extraction tool of claim 1 wherein the lead screw raises the lift member as it rotates in a counter-clockwise direction, thereby translating the component out of the CVD reactor.

14. The insertion/extraction tool of claim 1 wherein the lead screw lowers the lift member as it rotates in a clockwise direction, thereby translating the component out of the CVD reactor.

15. A method of inserting and extracting components in a housing, the method comprising:
a) attaching a clamp member to a component in the housing;
b) attaching a lift member to the clamp member;
c) attaching a bridge to the lift member with a lead screw that is threaded through a threaded member in the bridge and that is terminated at one end at a bearing on the lift member; and
d) rotating the lead screw to translate the component attached to the clamp member.

16. The method of claim 15 further comprising aligning the bridge to the lift member with guide pins that substantially prevent the lift member from rotating relative to the housing.

17. The method of claim 15 wherein the housing is a CVD reactor and the component comprises a dielectric support that is mechanically coupled to a turntable.

18. The method of claim 15 wherein the rotating the lead screw comprises rotating a hand wheel attached to a second end of the lead screw.

19. The method of claim 15 wherein the attaching the clamp member to the component in the housing comprises compressing an o-ring.

20. The method of claim 15 wherein the attaching a lift member to the clamp member comprises bolting the lift member to the clamp member.

21. The method of claim 15 wherein the rotating the lead screw to translate the component attached to the clamp member comprises rotating in a clockwise direction to insert the component.

22. The method of claim 15 wherein the rotating the lead screw to translate the component attached to the clamp member comprises rotating the lead screw in a counter-clockwise direction to extract the component.
